(19) United States
(12) Patent Application Publication
(10) Pub. No.: US 2010/0325342 A1
(43) Pub. Date: Dec. 23, 2010

(54) MEMORY CONTROLLER AND NONVOLATILE STORAGE DEVICE USING SAME

(75) Inventor: Toshiyuki Honda, Kyoto (JP)

Correspondence Address: HAMRE, SCHUMANN, MUELLER & LARSON P.C., P.O. BOX 2902, MINNEAPOLIS, MN, 55402-0902, US

(73) Assignee: PANASONIC CORPORATION, Kadoma-shi (JP)

(21) Appl. No.: 12/526,224

(22) PCT Filed: Jul. 16, 2008
(86) PCT No.: PCT/JP2008/001904

§ 371 Date: Aug. 6, 2009

(30) Foreign Application Priority Data
Jul. 20, 2007 (JP) 2007-190004

(51) Int. Cl. G06F 12/02

(52) U.S. Cl. 711/103; 711/E12.008

(57) ABSTRACT

In a controller (memory controller) (2) that performs drive control of first and second flash memories (nonvolatile memories) (3a, 3b) in which multilevel memory cells are used in physical blocks, 64 page groups each including physical pages (9) provided in these physical blocks (8) are defined with respect to the plurality of physical blocks (8), and the physical pages (9) of the physical blocks (8) are grouped so that the boundaries of the page groups are defined behind the physical page (9) as the n-th page.

### TECHNICAL FIELD

The present invention relates to a memory controller that performs drive control with respect to a nonvolatile memory such as a flash memory, particularly a multilevel flash memory including multilevel memory cells configured so as to be capable of storing information of two or more bits. The present invention also relates to a nonvolatile storage device using the foregoing memory controller.

### BACKGROUND ART

In recent years, a nonvolatile storage device, for example, a memory card has been used as a storage medium for a portable information terminal, etc., typified by a digital camera and a mobile telephone, and a market thereof has been expanding. Regarding such a nonvolatile storage device, the following has been proposed: a plurality of nonvolatile memories such as flash memories are provided to achieve high-speed writing of data, and data are interleaved and written in parallel in the plurality of nonvolatile memories.

Specifically, in a conventional nonvolatile storage device, as described in, for example, JP 6 (1994)-119128 A, physical blocks of a plurality of flash memories are combined, and tracks are configured so that one track is formed with a set of physical pages at the same position (see, for example, FIG. 2 of the foregoing publication). It is shown that in this conventional nonvolatile storage device, data can be written in parallel in a plurality of flash memories at a high speed by writing the data in an order in accordance with the order of the tracks.

As to the nonvolatile storage device, an increase in the capacity thereof is demanded, too, in addition to the above-described high-speed writing. To respond to this demand, not only the application of the micromachining in the semiconductor manufacturing process, but also the following has been attempted; a nonvolatile memory with use of the multilevel technique of causing one memory cell to store information (data) of two or more bits, for example, a multilevel flash memory in which multilevel memory cells are provided, has come into use.

More specifically, in a conventional nonvolatile storage device, threshold voltages for writing multilevel information into multilevel memory cells are assigned in a manner as described in JP 2004-192789 A (see FIG. 1, for example). Besides, the following also is described in the foregoing document: for this conventional nonvolatile storage device, a writing operation with respect to a physical page has to be controlled so that a distribution of threshold voltages for a second page should be narrower than that for a first page, whereby a program time for the second page is longer than that for the first page (see paragraph [0161], for example). Thus, a problem is implied in that the multilevel configuration of memory cells increases the writing time, though doubling the capacity.

Further, as described, for example, in JP 2001-325796A, for a conventional nonvolatile storage device, it is proposed that by using a cache in the nonvolatile memory to which the multilevel technique is applied, high-speed writing can be achieved. Besides, it is also described that in this conventional nonvolatile storage device, the cache is available upon low bit writing, while the cache is unavailable upon high bit writing (see FIG. 29 and paragraph [0115], for example).

Here, the data writing operation with respect to the multilevel flash memory shown in JP 2004-192789 A or JP 2001-325796 A described above will be described in detail, with reference to FIGS. 12 and 13.

FIG. 12 explains an order in which physical block of a multilevel flash memory are subjected to a writing operation in a conventional nonvolatile storage device. FIG. 13 is a timing chart showing a specific example of the data writing operation for writing data in the multilevel flash memory shown in FIG. 12.

As shown in FIG. 12, the physical block of the multilevel flash memory is composed of 128 physical pages with page numbers 0 to 127. In FIG. 12, the data numbers in frames on the right of the respective page numbers indicate the order in which the data are written in the physical block. In other words, in the physical block, data are written in a page number ascending order that is indicated by the page numbers of the physical pages. For these physical blocks, 64 multilevel memory cells, in each of which data indicating 2-bit information can be written, are used. More specifically, physical pages with the page numbers 0 and 1 are configured with one multilevel memory cell, and thereafter in the same manner, pages with two successive page numbers are allocated to one multilevel memory cell, whereby 128 physical pages are allocated to 64 multilevel memory cells. Further, in this physical block, two successive page numbers are allocated to the first and second pages on each multilevel memory cell. In other words, for example, the physical pages with the page numbers 0 and 1 are configured with the first and second pages of the multilevel memory cell, respectively.

In the conventional nonvolatile storage device, as shown in FIG. 13, a data writing operation is carried out by a memory controller, not shown, with respect to the physical pages of the physical block. It should be noted that in FIG. 13, “(a) Data transfer” indicates periods in which data to be written are transferred to a multilevel flash memory, and “(b) Program” indicates periods in which data actually are programmed in multilevel memory cells. Further, “(c) Busy signal” indicates whether transfer of data to the multilevel flash memory is allowed/not allowed; it is shown that when the signal is at a high level, the transfer of data is allowed, whereas when the signal is at a low level, the transfer of data is not allowed (this also applies to FIG. 15 mentioned later).

In other words, as shown in FIG. 13, in the multilevel flash memory, data 0 are transferred during a period from a time T100 to a time T101. Next, a program of the data 0 is started at the time T101. This program is a writing operation for writing data to the first page of the multilevel memory cell. Therefore, in the multilevel flash memory, the transfer of data is allowed also during a period while the programming is executed. For this reason, in the conventional nonvolatile storage device, the memory controller causes the programming of the data 0 and the transfer of the data 1 to be executed in parallel during a period from the time T101 to a time T102.

Subsequently, in the multilevel flash memory, programming of the data 1 is started at the time T102. This programming is a writing operation for writing data in the second page of the multilevel memory cell. Therefore, in the multilevel flash memory, transfer of data is not allowed during a period while the foregoing programming is executed. For this reason, in the conventional nonvolatile storage device, the memory controller causes only the programming of the data 1 to be executed, while not allowing transfer of subsequent data 2 to be executed, during a period from the time T102 to a time T103.

Thereafter, writing operations for writing data 2 and 3 are carried out in the same manner during a period from the time T103 to a time T106, and writing operations for writing data 4 and 5 are carried out in the same manner during a period from the time T106 to a time T109.

Next, a case where data are interleaved and written in parallel in two multilevel flash memories in the conventional nonvolatile storage device is described in detail, with reference to FIGS. 14 and 15.

FIG. 14 explains an order in which physical blocks of two multilevel flash memories are subjected to a writing operation in the conventional nonvolatile storage device. FIG. 15 is a timing chart showing a specific example of the data writing operation for writing data in the two multilevel flash memories shown in FIG. 14.

As shown in FIG. 14, in the conventional nonvolatile storage device, page groups are configured so as to extend to the physical blocks of two multilevel flash memories 1 and 2; that is, each of the page group is composed of physical pages having the same page numbers, the physical pages being included in the two physical blocks, respectively. More specifically, the page group 0 is composed of physical pages having the page number 0 included in the multilevel flash memories 1 and 2. The subsequent page groups 1 to 127 also are configured in the same manner in accordance with the page numbers of the physical pages. As a result, 128 page groups in total are defined with respect to the multilevel flash memories 1 and 2.

Further, these page groups are configured so that data are written in an order in accordance with order of the page group, and in the same page group, data are written in an order in accordance with the order of the multilevel flash memories. In other words, data 0, 1, 2, and 3 sequentially are written in a physical page having a page number 0 of the multilevel flash memory 1, in a physical page having a page number 0 of the multilevel flash memory 2, in a physical page having a page number 1 in the multilevel flash memory 1, and in a physical page having a page number 1 in the multilevel flash memory 2, respectively. Thus, 256 sets of data in total, from data 0 to data 255, are allocated to any of the 128 page groups, and written therein.

Then, in the conventional nonvolatile storage device, as illustrated in FIG. 15, a data writing operation is carried out by a memory controller, not shown, with respect to physical pages of the multilevel flash memories 1 and 2.

In other words, as shown in FIG. 15, during a period from a time T110 to a time T111, data 0 are transferred to the multilevel flash memory 1. Next, the programming of the data 0 is started at the time T111. During a period from this time Till to a time T112, the memory controller causes the transfer of the data 1 to the multilevel flash memory 2 to be performed. Subsequently, the memory controller causes the multilevel flash memory 2 to start programming the data 1 at the time T112, and causes the transfer of data 2 to the multilevel flash memory 1 to be performed during a period from this time T112 to a time T113.

Next, at the time T113, the memory controller causes the multilevel flash memory 1 to start programming the data 2, and causes the transfer of data 3 to the multilevel flash memory 2 to be performed during a period from this time T113 to a time T114. Subsequently, at the time T114, the memory controller causes the multilevel flash memory 2 to start programming data 3. For both of the multilevel flash memories 1 and 2, a period from the time T114 to a time T115 is a period for programming with respect to the second page, which is a period in which the data transfer is not allowed. Therefore, in the conventional nonvolatile storage device, the memory controller does not cause the transfer of data with respect to the multilevel flash memories 1 and 2 to be executed during the period from the time T114 to the time T115. Then, at the time T115, the programming of the data 2 ends, and then, the memory controller causes the transfer of data 4 to the multilevel flash memory 1 to be started at this time T115.

### DISCLOSURE OF INVENTION

The conventional nonvolatile storage device as described above, however, has a problem in that it is not possible to interleave and write data effectively in the nonvolatile memory in which multilevel memory cells are used. The following describes this in more detail. In the conventional nonvolatile storage device, as shown in FIG. 14, 128 page groups are configured in such a manner that physical pages having the same page number in the multilevel flash memories 1 and 2 form one group. Therefore, in the conventional nonvolatile storage device, effective transfer of data is impossible, owing to the relationship between the transfer of data and the programming of the multilevel memory cells.

More specifically, in the conventional nonvolatile storage device, a period, for example, from the time T114 to the time T115 in FIG. 15 is set as the period of programming with respect to second pages of the multilevel flash memories 1 and 2. Therefore, during this period, owing to programming characteristics of the multilevel memory cells, transfer of data cannot be executed to both of the multilevel flash memories 1 and 2. As a result, in the conventional nonvolatile storage device, it is not possible to enhance the efficiency of the operation of writing data with respect to the multilevel flash memories 1 and 2.

In light of the above-described problem, it is an object of the present invention to provide a memory controller capable of effectively interleaving and writing data with respect to a nonvolatile memory in which multilevel memory cells are used, and to provide a nonvolatile storage device in which the foregoing memory controller is used.

### PROBLEM TO BE SOLVED BY THE INVENTION

In order to achieve the above-described object, a memory controller according to the present invention is a memory controller for performing drive control with respect to a nonvolatile memory in which multilevel memory cells, each of which is configured to be capable of storing data of two or more bits, are used in physical blocks.

The memory controller includes a main control part configured to be capable of interleaving and writing data in a plurality of the physical blocks, wherein each of the plurality of physical blocks includes the multilevel memory cells, which are p in number, first to p-th multilevel memory cells (p is an integer of not less than 2).

In each of the p multilevel memory cells, n pages that are first to n-th pages are provided as physical pages that are writing units for data (n is an integer of not less than 2), wherein as compared with a time required for a data writing operation with respect to the first page, the time required for a data writing operation with respect to a subsequent page increases sequentially as the page number increases, and in the case where in each of the plurality of physical blocks, page numbers are allocated sequentially to all the physical pages provided in the p multilevel memory cells in a predetermined order, the main control part defines, in the plurality of physical blocks, a plurality of page groups that include the physical pages provided in the physical blocks, and groups the physical pages of the plurality of physical blocks so that boundaries between the page groups are defined behind the physical pages as the n-th pages.

With respect to a plurality of physical blocks into which data are interleaved and written, the main control part in the memory controller configured as described above defines a plurality of page groups including physical pages provided in the physical blocks. The main control part also groups the physical pages of the plurality of physical blocks so that the boundaries between page groups are defined behind the physical pages as the n-th pages. With this configuration, unlike the above-described conventional example, it is possible to prevent the programming characteristics of the multilevel memory cells from adversely affecting the data writing operation. As a result, it is possible to interleave and write data effectively in the nonvolatile memory in which the multilevel memory cells are used.

In the above-described memory controller, the main control part may group the physical pages of the plurality of physical blocks so that each of the plurality of page groups includes the physical pages having the same page numbers in the plurality of physical blocks.

In this case, the grouping of physical pages with respect to the plurality of physical blocks can be carried out easily, and the management of data written in physical pages can be facilitated, whereby the nonvolatile memory driving control can be carried out easily.

Further, in the foregoing memory controller, it is preferable that in the case where data to be written in the nonvolatile memory are fed from outside, when transfer of data to be written is performed with respect to, among the plurality of physical pages included in the page groups, one physical page as the first page, the main control part performs transfer of data to be written with respect to another physical page of the same physical block included in the same page group as the page group including the above-mentioned physical page, and when transfer of data to be written is performed with respect to the physical page as the n-th page, the main control part performs transfer of data to be written with respect to a physical page of a physical block other than the physical block that includes the above-mentioned physical page as the n-th page.

In this case, when a data writing operation with respect to a physical page as the n-th page is performed, transfer of data to be written can be performed with respect to a physical page of a physical block other than the physical block that includes the foregoing physical page as the n-th page. Therefore, data can be interleaved and written more surely and effectively.

Further, a nonvolatile storage device of the present invention includes:

a nonvolatile memory in which multilevel memory cells each of which is configured to be capable of storing data of two or more bits are used in physical blocks; and

any one of the memory controllers described above.

In the nonvolatile storage device configured as described above, the memory controller used is capable of effectively interleaving and writing data in the nonvolatile memory in which multilevel memory cells are used. Thus, the nonvolatile storage device capable of performing high-speed data writing can be configured easily.

### EFFECTS OF THE INVENTION

With the present invention, it is possible to provide a memory controller capable of effectively interleaving and writing data in a nonvolatile memory in which multilevel memory cells are used, and to provide a nonvolatile storage device in which the foregoing memory controller is used.

### BRIEF DESCRIPTION OF DRAWINGS

FIG. 1 is a block diagram illustrating a configuration of principal parts of a memory card in which a memory controller according to an embodiment of the present invention is used.

FIG. 2 illustrates a configuration of principal parts of a flash memory shown in FIG. 1.

FIG. 3 illustrates a configuration of a physical block shown in FIG. 2.

FIG. 4 illustrates specific exemplary page groups grouped by a main control part shown in FIG. 1 in the foregoing two flash memories.

FIG. 5 illustrates a specific page allocation in the foregoing two flash memories.

FIG. 6 is a timing chart showing a specific example of a data writing operation for writing data in the foregoing two flash memories.

FIG. 7 illustrates specific exemplary page groups that are grouped by a main control part of a memory controller according to Embodiment 2 of the present invention.

FIG. 8 illustrates specific page allocation in two flash memories shown in FIG. 7.

FIG. 9 is a timing chart showing a specific example of the data writing operation for writing data in two flash memories shown in FIG. 7.

FIG. 10 illustrates specific exemplary page groups that are grouped by a main control part of a memory controller according to Embodiment 3 of the present invention.

FIG. 11 is a timing chart showing a specific example of a data writing operation for writing data in the three flash memories shown in FIG. 10.

FIG. 12 explains an order in which physical block of a multilevel flash memory are subjected to a writing operation in a conventional nonvolatile storage device.

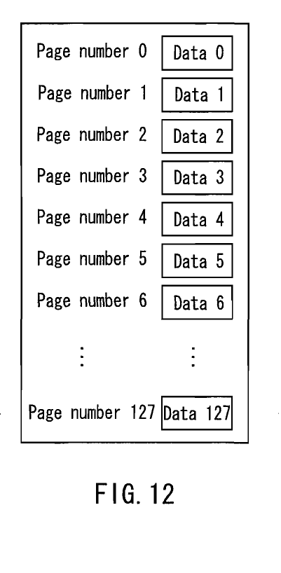

FIG. 13 is a timing chart showing a specific example of the data writing operation for writing data in the multilevel flash memory shown in FIG. 12.

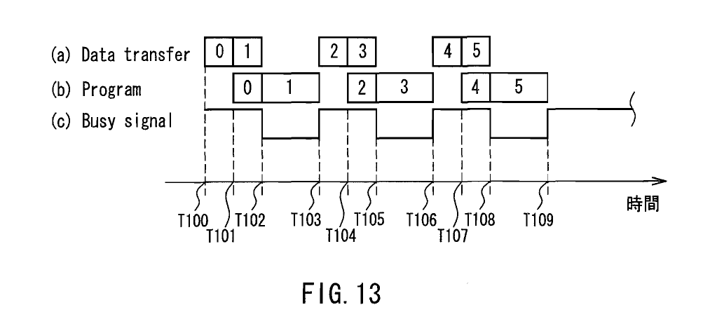

FIG. 14 explains an order in which physical blocks of two multilevel flash memories are subjected to a writing operation in the conventional nonvolatile storage device.

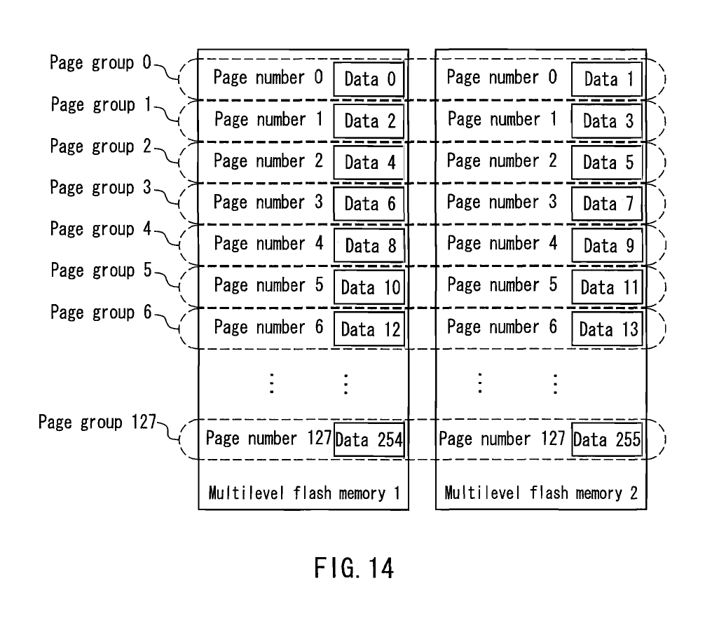

FIG. 15 is a timing chart showing a specific example of the data writing operation for writing data in the two multilevel flash memories shown in FIG. 14.

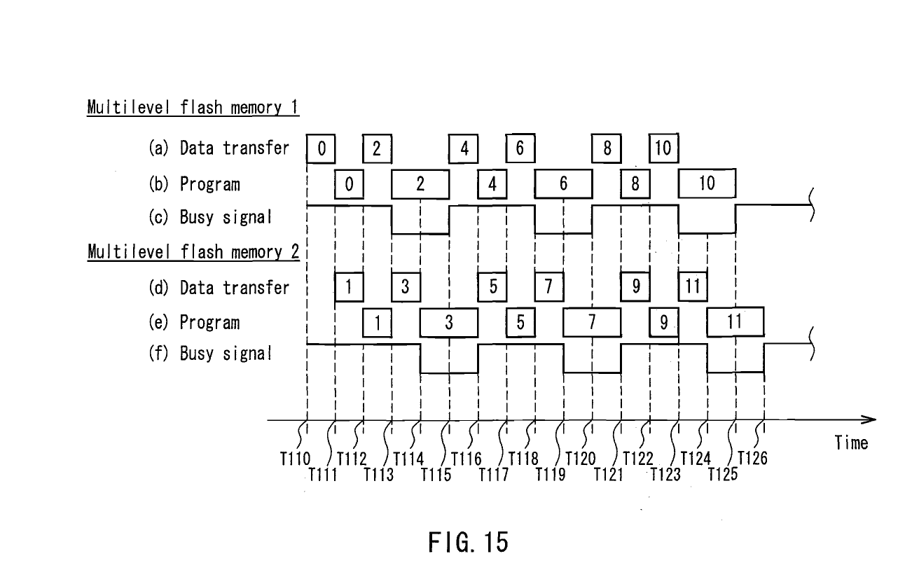

### DESCRIPTION OF THE INVENTION

The following describes preferred embodiments of a memory controller and a nonvolatile storage device according to the present invention, while referring to the drawings. It should be noted that the following description explains an exemplary case where the present invention is applied to a memory card as the nonvolatile storage device.

### Embodiment 1

### Configuration of a Nonvolatile Storage Device

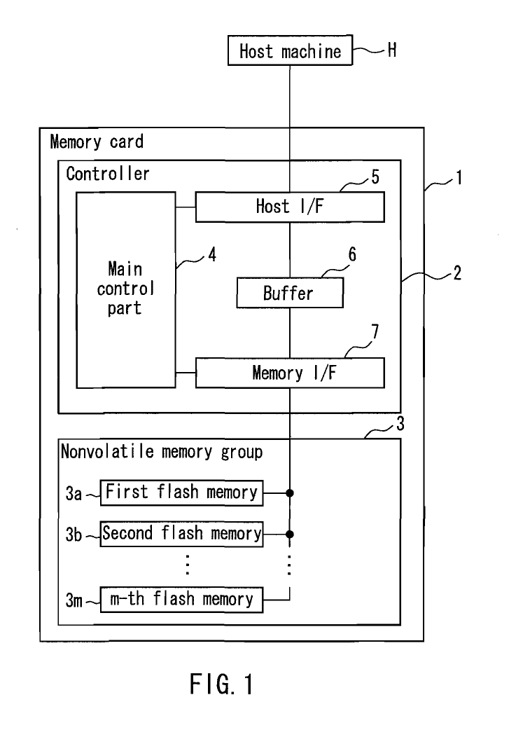

FIG. 1 is a block diagram illustrating a configuration of principal parts of a memory card in which a memory controller according to an embodiment of the present invention is used. In the drawing, a memory card 1 of the present embodiment is provided with a controller 2 configured with the memory controller of the present invention, and a nonvolatile memory group 3 in which m flash memories (m is an integer of not less than 2) are provided, which are first, second, . . . and m-th flash memories 3a, 3b, . . . 3m. As the first to m-th flash memories 3a, 3b, . . . , 3m of the nonvolatile memory group 3, flash memories of the same type, for example, the NAND type, are used, and data writing control and data reading control with respect to these are performed by the controller 2. Each of the first to m-th flash memories 3a, 3b, 3m is a multilevel flash memory in which multilevel memory cells are used. In other words, in each of the first to m-th flash memories 3a, 3b, . . . 3m, a plurality of physical blocks are included, and in each physical block, multilevel memory cells configured to be capable of storing 2-bit data (information) are used (details will be described later).

Further, a host machine H that provides the memory card 1 with an access instruction with designation of a logical address is provided to be connectable with the memory card 1, so that two-way transfer of data between the memory card 1 and the host machine H can be performed. It should be noted that the memory card 1 and the host machine H are incorporated in, for example, a digital camera, or a personal computer, and therein form a nonvolatile storage system for storing data.

The controller 2 is configured to perform writing and reading of data whose logical address is designated by an external element, with respect to the first to m-th flash memories 3a, 3b, . . . , 3m of the nonvolatile memory group 3. More specifically, the controller 2 writes data into the first to m-th flash memories 3a, 3b, . . . , 3m of the nonvolatile memory group 3, the data being transferred together with a writing request with a logical address being designated, from the host machine 1 provided outside the memory card 1; and in response to a reading request with a logical address being designated, from the host machine H, the controller 2 reads data from some of the first to m-th flash memories 3a, 3b, . . . , 3m of the nonvolatile memory group 3 corresponding to the foregoing logical address, and transfers the data to the host machine H.

The controller 2 includes a main control part 4; a host I/F 5 and a memory I/F 7 that are interfaces provided on the host machine H side and the nonvolatile memory group 3 side, respectively; and a buffer 6 provided between the host I/F 5 and the memory I/F 7.

As the main control part 4, a CPU or a DSP is used, to which the writing request or the reading request from the host machine H is fed. The main control part 4 is configured to perform a driving control with respect to respective parts of the controller 2, according to a writing request or a reading request fed thereto. Additionally, the main control part 4 is configured so that data are interleaved and written in parallel into the first to m-th flash memories 3a, 3b, . . . , 3m of the nonvolatile memory group 3.

Further, as described later, the main control part 4 is configured so that according to page allocation set in the first to m-th flash memories 3a, 3b, . . . , 3m, a plurality of physical pages defined in the physical blocks of the first to m-th flash memories 3a, 3b, . . . , 3m are allocated and grouped into a plurality of page groups through predetermined steps. It should be noted that the main control part 4 is configured to respond appropriately to an access instruction from the host machine H, by interconverting logical addresses from the host machine H and addresses of corresponding ones of the physical pages of the first to m-th flash memories 3a, 3b, . . . , 3m, by referring to an address conversion table (not shown).

The host I/F 5 controls the interface between the memory card 1 and the host machine H pursuant to an instruction from the main control part 4, and performs transfer of data between the memory card 1 and the buffer 6. The buffer 6 is formed with, for example, a volatile memory, so as to store temporarily data that are supplied to and from the memory card 1. The memory I/F 7 controls the first to m-th flash memories 3a, 3b, . . . , 3m of the nonvolatile memory group 3, which are connected in parallel, pursuant to an instruction from the main control part 4, while performing data transfer between the buffer 6 and the nonvolatile memory group 3.

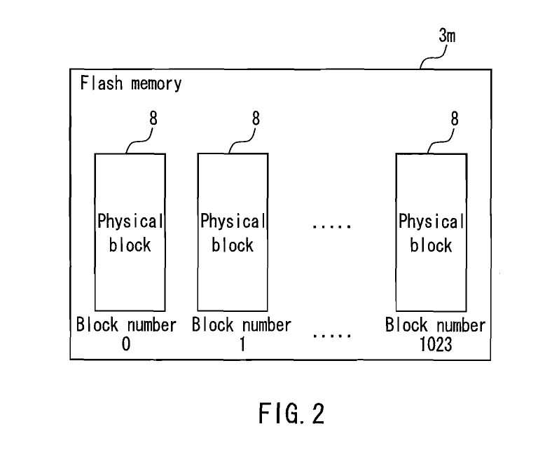

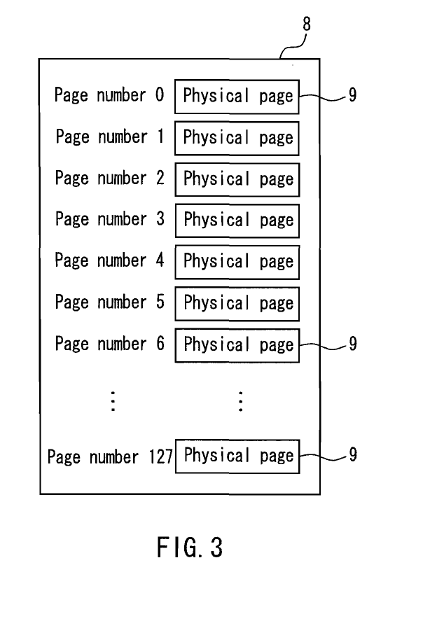

Next, the first to m-th flash memories 3a, 3b, . . . , 3m and physical blocks are described in detail, with reference to FIGS. 2 and 3. It should be noted that the following description discusses the m-th flash memory 3m as an example, from the first to m-th flash memories 3a, 3b, . . . , 3m, which are configured to be identical to one another.

FIG. 2 illustrates a configuration of principal parts of a flash memory shown in FIG. 1, and FIG. 3 illustrates a configuration of a physical block shown in FIG. 2.

As shown in FIG. 2, the m-th flash memory 3m includes, for example, 1024 physical blocks 8 having block numbers 0 to 1023. This physical block 8 is an erasure unit for data of the m-th flash memory 3m.

In each physical block 8, as shown in FIG. 3, for example, 128 physical pages 9 having page numbers 0 to 127 are defined. This physical page 9 is a writing unit for data of the m-th flash memory 3m, and also is a reading unit for the data.

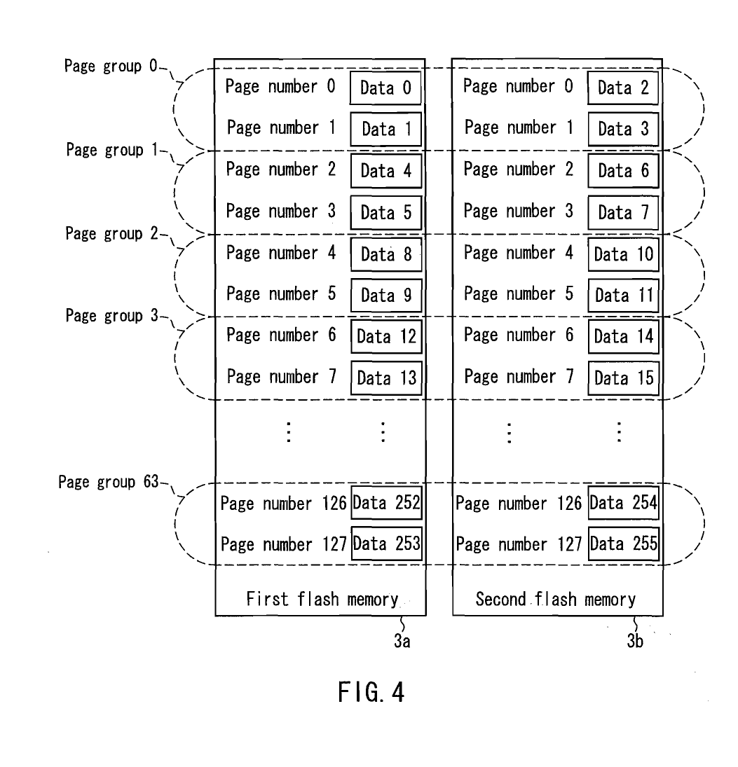

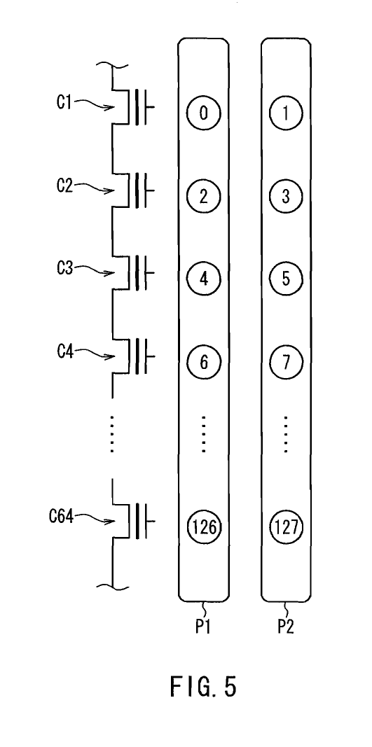

The following specifically describes a configuration of page groups of physical pages of physical blocks according to the present embodiment, while referring to FIGS. 4 and 5. It should be noted that, for simplification of description, the following describes an exemplary case where the main control part 4 groups physical pages 9 of physical blocks 8 of the first and second flash memories 3a and 3b, so as to configure a plurality of page groups.

FIG. 4 illustrates specific exemplary page groups grouped by the main control part shown in FIG. 1 in the foregoing two flash memories. FIG. 5 illustrates a specific page allocation in the foregoing two flash memories.

First, the following specifically describes page allocation with respect to the multilevel memory cells provided in the physical blocks 8 of each of the first and second flash memories 3a and 3b, while referring to FIG. 5. In FIG. 5, in each of the first and second flash memories 3a and 3b, a set of 64 multilevel memory cells C1, C2, . . . , C64 is provided as a base unit. A plurality of base units, for example, 19896 base units, form one physical block 8. The multilevel memory cells C1, C2, . . . , C64 belong to two different physical pages 9. In other words, the 19896 multilevel memory cells C1 included in the same physical block 8 belong to two different physical pages. The two physical pages that these multilevel memory cells C1 belong to are a first page P1 and a second page P2. This applies to the multilevel memory cells C2, . . . , C64. In other words, in each of the multilevel memory cells C1, C2, . . . , C64, there are defined the first page P1, as well as the second page P2 that requires a longer time for programming data (a data writing operation) as compared with the first page P1. The first page P1 and the second page P2 constitute the above-described physical pages 9. Further, each of the multilevel memory cells C1, C2, . . . , C64 is configured so that each of the first page P1 and the second page P2 holds data of 0 or 1.

Further, in the physical block 8, the page numbers of the physical pages 9 in a predetermined order are allocated to the first page P1 and the second page P2 of each of the multilevel memory cells C1, C2, . . . , C64. More specifically, as shown in FIG. 5, the page numbers 0 and 1 of the physical pages 9 are allocated to the first page P1 and the second page P2 of the multilevel memory cell C1, respectively. The page numbers 2 and 3 of the physical pages 9 are allocated to the first page P1 and the second page P2 of the multilevel memory cell C2, respectively. The subsequent page numbers 4, 5, 6, 7, . . . , 126, 127 of the physical pages 9 also successively are allocated in the same manner to the first pages P1 and the second pages P2 of the multilevel memory cells C3, C4, . . . , C64, respectively.

Further, in the memory card 1, page allocation information as described above regarding the allocation of page numbers of the physical pages 9 to the first page P1 and the second page P2 of each of the multilevel memory cells C1, C2, . . . , C64 in the physical block 8 is held by the main control part 4 in advance. Then, based on the page allocation information thus held, with respect to the physical blocks 8 of the first and second flash memories 3a and 3b, the main control part 4 provides a plurality of page groups that include the physical pages 9 defined in the foregoing physical blocks 8. Further, the main control part 4 groups the physical pages 9 of a plurality of the physical blocks 8 in such a manner that boundaries between the page groups are defined behind the second pages P2.

More specifically, as shown in FIG. 4, the main control part 4 groups the physical pages 9 of the physical blocks 8 of the first and second flash memories 3a and 3b, so as to define 64 page groups 0, 1, 2, . . . , 63 in these two physical blocks 8. In other words, the physical pages 9 having the page numbers 0 and 1 in the two physical blocks 8, which are four physical pages 9 in total, are included in a page group 0, whereby the page group 0 is formed. Subsequent page groups 1 to 63 are formed in the same manner, in which four physical pages 9 having two successive page numbers in the physical blocks 8 form each page group.

Besides, a boundary between page groups, for example, a boundary between the page groups 0 and 1, is defined between the multilevel memory cell C1 and the multilevel memory cell C2 of each physical block 8, and the first page P1 of the multilevel memory cell C1 (the physical page 9 having the page number 0) and the next physical page 9 having the page number 1, i.e., the second page P2 of the multilevel memory cell C1, belong to the same page group 0. Behind the second page P2 of the multilevel memory cell C1 (the physical page 9 having the page number 1), the boundary between the page groups 0 and 1 is defined.

Then, when data to be written in the first and second flash memories 3a and 3b are fed from outside, the main control part 4 performs the following: when transfer of data to be written is performed with respect to, among the plurality of physical pages 9 included in any one of the page groups, one physical page 9 other than that as the second page P2, transfer of data to be written is performed with respect to another physical page 9 of the same physical block 8 (i.e., one of the first and second flash memories 3a and 3b) included in the same page group as the page group including the above-mentioned physical page 9; and when transfer of data to be written is performed with respect to the physical page 9 as the second page 2, transfer of data to be written is performed with respect to a physical page 9 of a physical block 8 (i.e, the other of the first and second flash memories 3a and 3b) other than the physical block 8 that includes the above-mentioned physical page 9 as the second page P2. With such transfer of data to be written being performed, the data 0 to 255, which are 256 sets of data in total, are written, in units of physical pages 9, in the first and second flash memories 3a and 3b, as shown in FIG. 4.

The following specifically describes a data processing operation in the present embodiment configured as described above, while referring to FIGS. 1 to 6. It should be noted that the following describes a writing operation in which data are interleaved and written in parallel in the first and second flash memories 3a and 3b that are subjected to grouping as described above.

[Data Writing Operation]

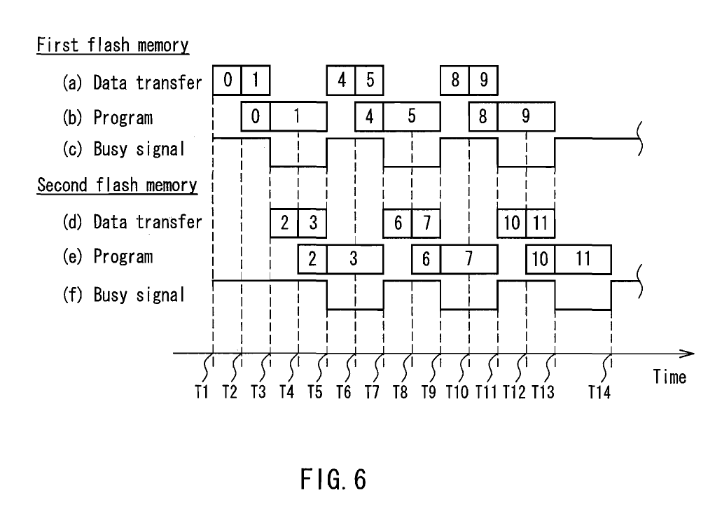

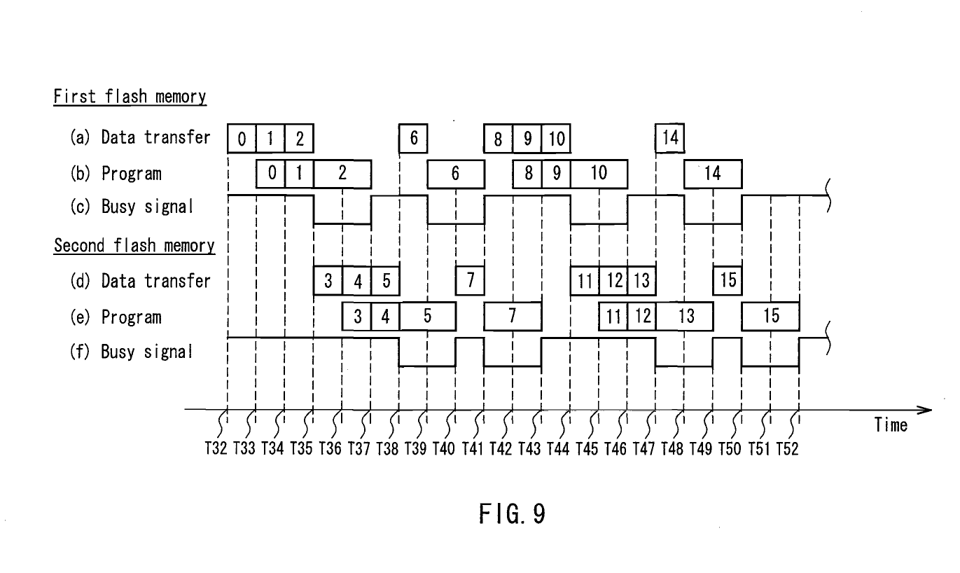

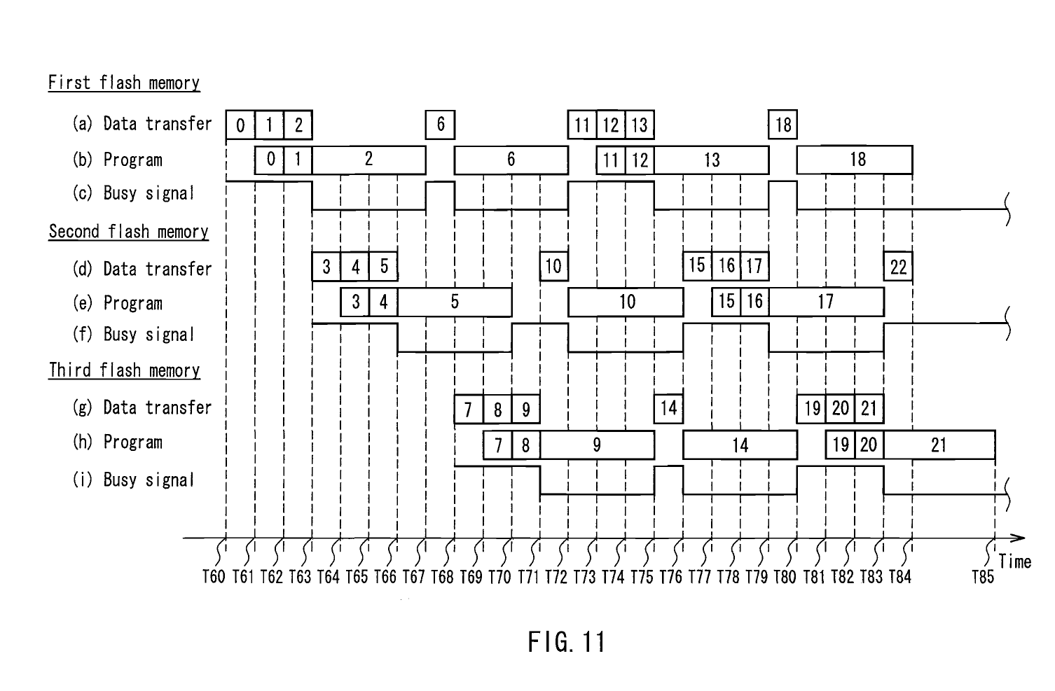

FIG. 6 is a timing chart showing a specific example of a data writing operation for writing data in the foregoing two flash memories. It should be noted that “(a) Data transfer” and “(d) Data transfer” in FIG. 6 indicate periods for transferring data to be written to the corresponding first and second flash memories 3a and 3b, and “(b) Programming” and “(e) Programming” indicate periods for actually programming the data in the corresponding first and second flash memories 3a and 3b. Further, “(c) Busy signal” and “(f) Busy signal” show data transferability with respect to the corresponding first and second flash memories 3a and 3b. They show that when the busy signal is at a high level, the data transfer is allowed, while when the busy signal is at a low level, the data transfer is not allowed (this applies to FIGS. 9 and 11 referred to later).

As shown in FIG. 6, the main control part 4 transfers data 0 to the first flash memory 3a during a period from a time T1 to a time T2. Next, at the time T2, the main control part 4 causes the programming of the data 0 to be started. Since a period from this time T2 to a time T3 for programming the data 0 is a period for writing data in the first page P1 of the multilevel memory cell C1, the main control part 4 is supplied with a high-level busy signal from the first flash memory 3a. Therefore, during the period from the time T2 to the time T3, the main control part 4 continuously transfers data 1 to the first flash memory 3a using a cache program, without switching to the second flash memory 3b.

Then, at the time T3 when the main control part 4 causes the programming of the data 1 to be started and a low-level busy signal is supplied from the first flash memory 3a, the main control part 4 switches the destination of transfer of data to the second flash memory 3b, and transfers data 2 to the second flash memory 3b during a period from the time T3 to a time T4. Next, at the time T4, the main control part 4 causes the programming of the data 2 to be started. Since a period from this time T4 to a time T5 for programming the data 2 is a period for writing data in the first page P1 of the multilevel memory cell C1, the main control part 4 is supplied with a high-level busy signal from the second flash memory 3b. Therefore, during the period from the time T4 to the time T5, the main control part 4 continuously transfers data 3 to the second flash memory 3b using a cache program, without switching to the first flash memory 3a.

Subsequently, at the time T5, the main control part 4 causes the programming of the data 3 to be started, a low-level busy signal is supplied from the second flash memory 3b, the programming of the data 1 ends, and a high-level busy signal is supplied from the first flash memory 3a. Then, the main control part 4 switches the destination of transfer of data to the first flash memory 3a, and transfers data 4 to the first flash memory 3a during a period from the time T5 to a time T6. Next, at the time T6, the main control part 4 causes the programming of the data 4 to be started. Since a period from this time T6 to a time T7 for programming the data 4 is a period for writing data in the first page P1 of the multilevel memory cell C2, the main control part 4 is supplied with a high-level busy signal from the first flash memory 3a. Therefore, during the period from the time T6 to the time T7, the main control part 4 continuously transfers data 5 to the first flash memory 3a using a cache program, without switching to the second flash memory 3b. Thereafter, the main control part 4 performs the same data transfer with respect to the first and second flash memories 3a and 3b, so that data are written therein.

As described above, in the controller (memory controller) 2 of the present embodiment, with respect to the two physical blocks 8 of the first and second flash memories (nonvolatile memories) 3a and 3b in which data are interleaved and written, the main control part 4 defines 64 page groups 0 to 63 including the physical pages 9 defined in the respective physical blocks 8. Besides, the main control part 4 groups the physical pages 9 of the foregoing two physical blocks 8 in such a manner that boundaries between the page groups come behind the physical pages 9 as the second pages P2. With this configuration, unlike the above-described conventional example, it is possible to prevent the programming characteristics of the multilevel memory cells from adversely affecting the data writing operation. As a result, the controller 2 of the present embodiment is capable of effectively interleaving and writing data in the first and second flash memories 3a and 3b in which the multilevel memory cells C1 to C64 are used. Further, in the present embodiment, since the controller 2 capable of effectively interleaving and writing data is used, it is possible to configure easily the memory card (nonvolatile storage device) 1 capable of performing high-speed data writing.

Further, in the present embodiment, as shown in FIG. 6, for example, during a period from the time T3 to the time T5 while data are written in the physical page 9 as the second page of the physical block 8 of the first flash memory 3a, data to be written are transferred to the physical page 9 of the physical block 8 of the second flash memory 3b. Therefore, data can be interleaved and written more surely and effectively in these first and second flash memories 3a and 3b.

### Embodiment 2

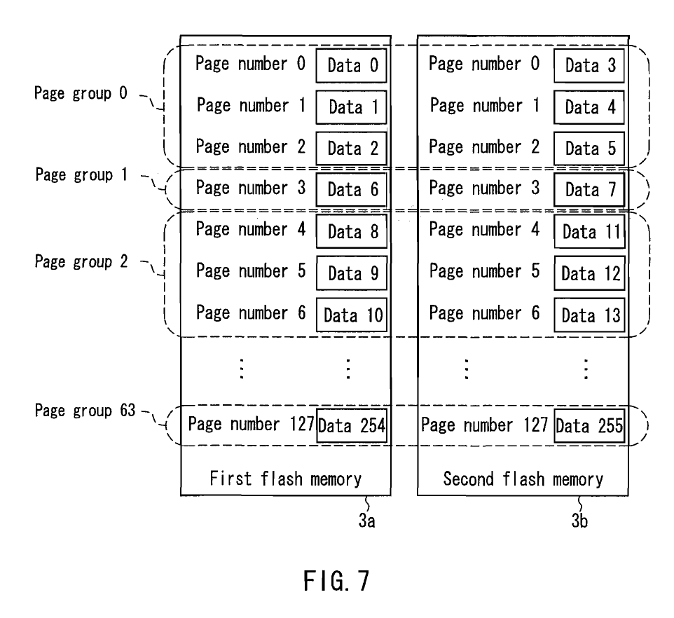

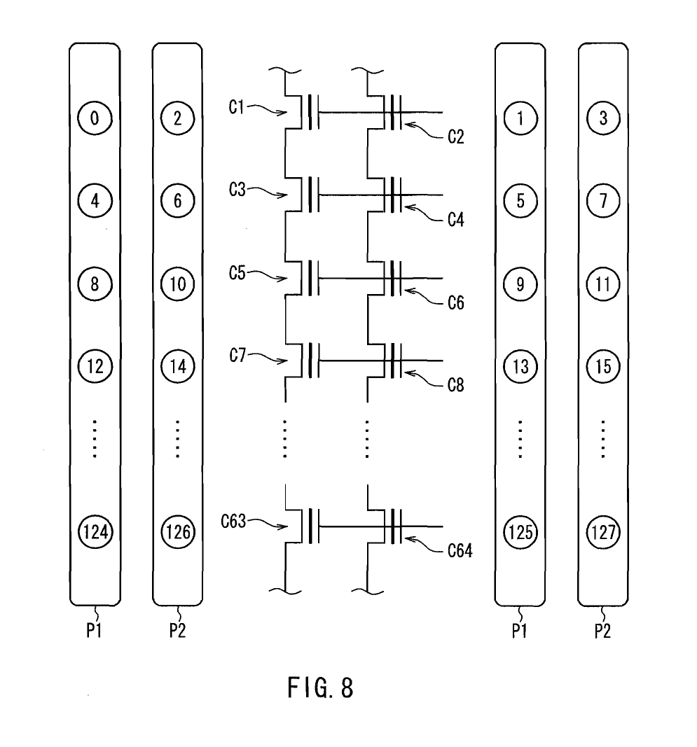

FIG. 7 illustrates specific exemplary page groups that have been grouped by a main control part of a memory controller according to Embodiment 2 of the present invention, and FIG. 8 illustrates specific page allocation in two flash memories shown in FIG. 7. In the drawings, a main difference between the present embodiment and Embodiment 1 described above is that when allocation of physical pages in one multilevel memory cell is different from that in the other multilevel memory cell, the main control part changes the manner of grouping of physical pages in accordance with the page allocation, thereby changing the configuration of page groups. It should be noted that the same elements as those in Embodiment 1 described above are designated with the same reference numerals, and duplicate descriptions of the same are omitted.

In physical blocks 8 of first and second flash memories 3a and 3b of the present embodiment, as shown in FIG. 8, one odd-numbered multilevel memory cell and one even-numbered multilevel memory cell are paired. With respect to two first pages P1 and two second pages P2 included in the foregoing two multilevel memory cells, page numbers of the physical pages 9 are allocated in a predetermined order in which the first page P1 is given precedence. More specifically, page numbers 0 and 2 of the physical pages 9 are allocated to a first page P1 and a second page P2 of a multilevel memory cell C1, respectively. Further, page numbers 1 and 3 of the physical pages 9 are allocated to a first page P1 and a second page P2 of a multilevel memory cell C2, respectively.

Thereafter, page numbers 4 and 6 of the physical pages 9 are allocated to a first page P1 and a second page P2 of a multilevel memory cell C3, respectively, and page numbers 5 and 7 of the physical pages 9 are allocated to a first page P1 and a second page P2 of a multilevel memory cell C4, respectively. Page numbers 124 and 126 of the physical pages 9 are allocated to a first page P1 and a second page P2 of a multilevel memory cell C63, respectively, and page numbers 125 and 127 of the physical pages 9 are allocated to a first page P1 and a second page P2 of a multilevel memory cell C64, respectively. Information of this page allocation in the physical block 8 is held by the main control part 4 in advance. Based on the page allocation information thus held, the main control part 4 groups the physical pages 9 of the physical blocks 8 of the first and second flash memories 3a and 3b.

More specifically, in the present embodiment, as shown in FIG. 7, the main control part 4 performs the grouping of the physical pages 9 in such a manner that the number of the physical pages 9 included in an even-numbered page group and the number of the physical pages 9 included in an odd-numbered page group are made different from each other. More specifically, the main control part 4 configures a page group 0 by including the physical pages 9 having page numbers 0, 1, and 2 in the two physical blocks 8, which are six physical pages 9 in total, into the page group 0. It also configures a page group 1 by including the physical pages 9 having a page number 3 in the foregoing physical blocks 8, which are two physical pages 9 in total, into the page group 1. Thereafter, each of the subsequent even-numbered page groups 2, . . . , 62 is formed with six physical pages 9 having three successive page numbers in the foregoing physical blocks 8, while each of the subsequent odd-numbered page groups 3, . . . , 63 is formed with two physical pages 9 having one page number in the foregoing physical blocks 8.

Further, in the present embodiment, the main control part 4 defines boundaries between the page groups behind the second pages P2 of the multilevel memory cells. In other words, for example, a boundary between the page group 0 and the page group 1 is defined behind the second page P2 of the multilevel memory cell C1 in each physical block 8. Likewise, a boundary between the page group 1 and the page group 2 is defined behind the second page P2 of the multilevel memory cell C2 in each physical block 8.

Then, when data to be written in the first and second flash memories 3a and 3b are fed from outside, the main control part 4 performs the following: when transfer of data to be written is performed with respect to, among the plurality of physical pages 9 included in any one of the page groups, one physical page 9 other than that as the second page P2, transfer of data to be written is performed with respect to another physical page 9 of the same physical block 8 (i.e., one of the first and second flash memories 3a and 3b) included in the same page group as the page group including the above-mentioned physical page 9; and when transfer of data to be written is performed with respect to the physical page 9 as the second page 2, transfer of data to be written is performed with respect to a physical page 9 of a physical block 8 (i.e, the other of the first and second flash memories 3a and 3b) other than the physical block 8 that includes the above-mentioned physical page 9 as the second page P2. With such transfer of data to be written being performed, the data 0 to 255, which are 256 sets of data in total, are written, in units of physical pages 9, in the first and second flash memories 3a and 3b, as shown in FIG. 7.

[Data Writing Operation]

The following describes a data writing operation in the present embodiment, while referring to FIG. 9.

FIG. 9 is a timing chart showing a specific example of the data writing operation for writing data in two flash memories shown in FIG. 7.

As shown in FIG. 9, the main control part 4 transfers data 0 to the first flash memory 3a during a period from a time T32 to a time T33. Next, at the time T33, the main control part 4 causes the programming of data 0 to be started. Since a period from this time T33 to a time T34 for programming the data 0 is a period for writing data in the first page P1 of the multilevel memory cell C1, the main control part 4 is supplied with a high-level busy signal from the first flash memory 3a. Therefore, during the period from the time T33 to the time T34, the main control part 4 continuously transfers data 1 to the first flash memory 3a using a cache program, without switching to the second flash memory 3b.

Next, the main control part 4 causes the programming of data 1 to be started at the time T34. Since a period from this time T34 to a time T35 for programming the data 1 is a period for writing data in the first page P1 of the multilevel memory cell C2, the main control part 4 is supplied with a high-level busy signal from the first flash memory 3a. Therefore, during the period from the time T34 to the time T35, the main control part 4 continuously transfers data 2 to the first flash memory 3a using a cache program, without switching to the second flash memory 3b.

Then, at the time T35 when the main control part 4 causes the programming of the data 2 to be started and a low-level busy signal is supplied from the first flash memory 3a, the main control part 4 switches the destination of transfer of data to the second flash memory 3b, and transfers data 3 to the second flash memory 3b during a period from the time T35 to a time T36. Next, at the time T36, the main control part 4 causes the programming of the data 3 to be started. Since a period from this time T36 to a time T37 for programming the data 3 is a period for writing data in the first page P1 of the multilevel memory cell C1, the main control part 4 is supplied with a high-level busy signal from the second flash memory 3b. Therefore, during the period from the time T36 to the time T37, the main control part 4 continuously transfers data 4 to the second flash memory 3b using a cache program, without switching to the first flash memory 3a.

Next, at the time T37, the main control part 4 causes the programming of the data 4 to be started. Since a period from this time T37 to a time T38 for programming the data 4 is a period for writing data in the first page P1 of the multilevel memory cell C2, the main control part 4 is supplied with a high-level busy signal from the second flash memory 3b. Therefore, during the period from the time T37 to the time T38, the main control part 4 continuously transfers data 5 to the second flash memory 3b using a cache program, without switching to the first flash memory 3a.

Then, at the time T38 when the main control part 4 causes the programming of the data 5 to be started and a low-level busy signal is supplied from the second flash memory 3b, the main control part 4 switches the destination of transfer of data to the first flash memory 3a, and transfers data 6 to the first flash memory 3a during a period from the time T38 to a time T39. Next, at the time T39, the main control part 4 causes the programming of the data 6 to be started. Since a period from this time T39 to a time T41 for programming the data 6 is a period for writing data in the second page P2 of the multilevel memory cell C2, the main control part 4 is supplied with a low-level busy signal from the first flash memory 3a. Therefore, during the period from the time T39 to the time T41, the main control part 4 is not allowed to transfer data to the first flash memory 3a.

On the other hand, at the time T40 when the programming of the data 5 ends and a high-level busy signal is supplied from the second flash memory 3b, the main control part 4 determines that the second flash memory 3b is ready for receiving data transferred thereto, switches the destination of transfer of data to the second flash memory 3b, and transfers data 7 to the second flash memory 3b during a period from the time T40 to a time T41. Then, the main control part 4 causes the programming of the data 7 to be started at the time T41. Since a period from this time T41 to a time T43 for programming the data 7 is a period for writing data in the second page P2 of the multilevel memory cell C2, the main control part 4 is supplied with a low-level busy signal from the second flash memory 3b. Therefore, during the period from the time T41 to the time T43, the main control part 4 is not allowed to transfer data to the second flash memory 3b.

On the other hand, at the time T41 when the programming of the data 6 ends and a high-level busy signal is supplied from the first flash memory 3a, the main control part 4 determines that the first flash memory 3a is ready for receiving data transferred thereto, switches the destination of transfer of data to the first flash memory 3a, and transfers data 8 to the first flash memory 3a during a period from this time T41 to a time T42. Thereafter, the main control part 4 performs the same data transfer operation with respect to the first and second flash memories 3a and 3b, so that data are written therein.

With the above-described configuration, the present embodiment achieves the same effects as those of Embodiment 1 described above.

### Embodiment 3

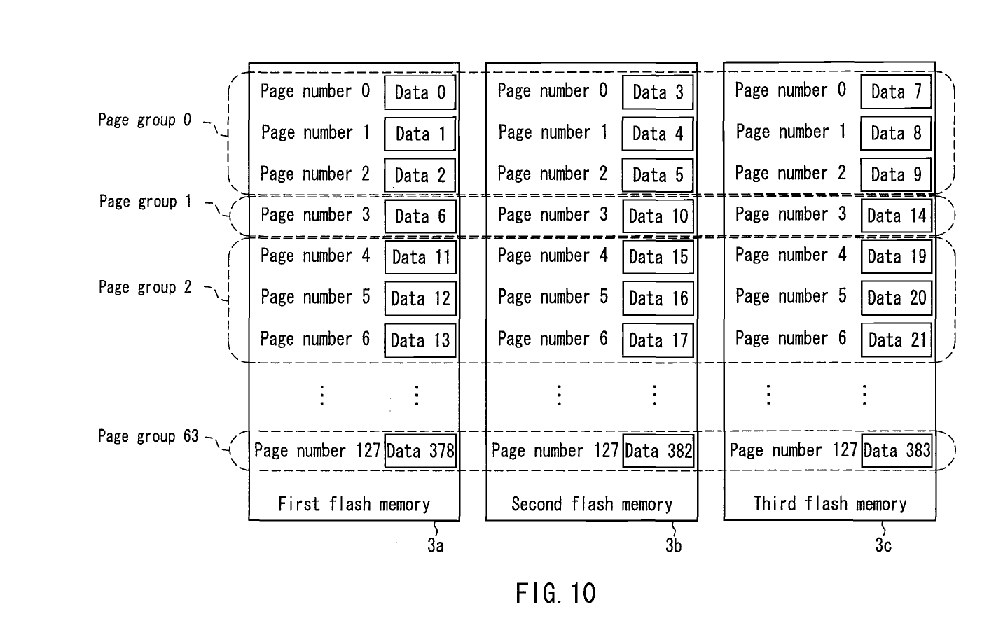

FIG. 10 illustrates specific exemplary page groups that are grouped by a main control part of a memory controller according to Embodiment 3 of the present invention. In the drawing, a main difference between the present embodiment and Embodiment 2 described above is that when three flash memories are used in a nonvolatile memory group, the main control part changes the manner of grouping of physical pages in accordance with the nonvolatile memory group, thereby changing the configuration of page groups. It should be noted that the same elements as those in Embodiment 2 are designated with the same reference numerals, and duplicate descriptions of the same are omitted.

More specifically, as shown in FIG. 10, in the present embodiment, a main control part 4 groups physical pages 9 of physical blocks 8 of first to third flash memories 3a, 3b, and 3c included in a nonvolatile memory group 3. Further, in the physical blocks 8 of each of the flash memories 3a, 3b, and 3c, the page numbers of the physical pages 9 are allocated to first pages P1 and second pages P2 of multilevel memory cells C1 to C64 in accordance with the page allocation shown in FIG. 8. The main control part 4 of the present embodiment, like in Embodiment 2, forms each of the even-numbered pages groups 0, . . . , 62 with physical pages 9 of having three successive page numbers in the foregoing three physical blocks 8, which are nine physical pages 9 in total, while forming each of the odd-numbered page groups 1, . . . , 63 with physical pages 9 of having one page number in the foregoing physical blocks 8, which are three physical pages 9 in total. Besides, the main control part 4 defines boundaries between the page groups behind the second pages P2 of the multilevel memory cells, like in Embodiment 2.

Further, in the case where data to be written in the first to third flash memories 3a to 3c are fed from outside, the main control part 4 in the present embodiment performs the following, like in Embodiments described above: when transfer of data to be written is performed with respect to, among the plurality of physical pages 9 included in any one of the page groups, one physical page 9 other than that as the second page P2, transfer of data to be written is performed with respect to another physical page 9 of the same physical block 8 (i.e., one of the first to third flash memories 3a to 3c) included in the same page group as the page group including the above-mentioned physical page 9; and when transfer of data to be written is performed with respect to the physical page 9 as the second page 2, transfer of data to be written is performed with respect to a physical page 9 of a physical block 8 (i.e, one of the first to third flash memories 3a to 3c that is other than the foregoing one of the first to third flash memories 3a to 3c) other than the physical block 8 that includes the above-mentioned physical page 9 as the second page P2. With such transfer of data to be written being performed, the data 0 to 383, which are 384 sets of data in total, are written, in units of physical pages 9, in the first to third flash memories 3a to 3c, as shown in FIG. 10.

[Data Writing Operation]

The following describes a data writing operation in the present embodiment, while referring to FIG. 11.

FIG. 11 is a timing chart showing a specific example of a data writing operation for writing data in the three flash memories shown in FIG. 10.

As shown in FIG. 11, the main control part 4 transfers data 0 to the first flash memory 3a during a period from a time T60 to a time T61. Next, at the time T61, the main control part 4 causes the programming of data 0 to be started. Since a period from this time T61 to a time T62 for programming the data 0 is a period for writing data in the first page P1 of the multilevel memory cell C1, the main control part 4 is supplied with a high-level busy signal from the first flash memory 3a. Therefore, during the period from the time T61 to the time T62, the main control part 4 continuously transfers data 1 to the first flash memory 3a using a cache program, without switching to the second or third flash memory 3b or 3c.

Next, the main control part 4 causes the programming of data 1 to be started at the time T62. Since a period from this time T62 to a time T63 for programming the data 1 is a period for writing data in the first page P1 of the multilevel memory cell C2, the main control part 4 is supplied with a high-level busy signal from the first flash memory 3a. Therefore, during the period from the time T62 to the time T63, the main control part 4 continuously transfers data 2 to the first flash memory 3a using a cache program, without switching to the second or third flash memory 3b or 3c.

Then, at the time T63 when the main control part 4 causes the programming of the data 2 to be started and a low-level busy signal is supplied from the first flash memory 3a, the main control part 4 switches the destination of transfer of data to, for example, the second flash memory 3b, and transfers data 3 to the second flash memory 3b during a period from the time T63 to a time T64. Next, at the time T64, the main control part 4 causes the programming of the data 3 to be started. Since a period from this time T64 to a time T65 for programming the data 3 is a period for writing data in the first page P1 of the multilevel memory cell C1, the main control part 4 is supplied with a high-level busy signal from the second flash memory 3b. Therefore, during the period from the time T64 to the time T65, the main control part 4 continuously transfers data 4 to the second flash memory 3b using a cache program, without switching to the first or third flash memory 3a or 3c.

Next, at the time T65, the main control part 4 causes the programming of the data 4 to be started. Since a period from this time T65 to a time T66 is a period for writing data in the first page P1 of the multilevel memory cell C2, the main control part 4 is supplied with a high-level busy signal from the second flash memory 3b. Therefore, during the period from the time T65 to the time T66, the main control part 4 continuously transfers data 5 to the second flash memory 3b using a cache program, without switching to the first or third flash memory 3a or 3c.

Next, at the time T66, the main control part 4 causes the programming of the data 5 to be started. Since a period from this time T66 to a time T70 for programming the data 5 is a period for writing data in the second page P2 of the multilevel memory cell C1, the main control part 4 is supplied with a low-level busy signal from the second flash memory 3b. Therefore, during the period from the time T66 to the time T70, the main control part 4 is not allowed to transfer data to the second flash memory 3b.

On the other hand, at the time T67 when the programming of the data 2 ends and a high-level busy signal is supplied from the first flash memory 3a, the main control part 4 determines that the first flash memory 3a is ready for receiving data transferred thereto, switches the destination of transfer of data to the first flash memory 3a, and transfers data 6 to the first flash memory 3a during a period from the time T67 to a time T68. Then, the main control part 4 causes the programming of the data 6 to be started at the time T68. Since a period from this time T68 to a time T72 for programming the data 6 is a period for writing data in the second page P2 of the multilevel memory cell C2, the main control part 4 is supplied with a low-level busy signal from the first flash memory 3a. Therefore, during the period from the time T68 to the time T71, the main control part 4 is not allowed to transfer data to the first flash memory 3a.

Therefore, the main control part 4 switches the destination of transfer of data to the third flash memory 3c, and transfers data 7 to the third flash memory 3c during a period from the time T68 to a time T69. Next, at the time T69, the main control part 4 causes the programming of the data 7 to be started. Since a period from this time T69 to a time T70 for programming the data 7 is a period for writing data in the first page P1 of the multilevel memory cell C1, the main control part 4 is supplied with a high-level busy signal from the third flash memory 3c. Therefore, during the period from the time T69 to the time T70, the main control part 4 continuously transfers data 8 to the third flash memory 3c using a cache program, without switching to the first or second flash memory 3a or 3b.

Next, at the time T70, the main control part 4 causes the programming of the data 8 to be started. Since a period from this time T70 to a time T71 for programming the data 8 is a period for writing data in the first page P1 of the multilevel memory cell C2, the main control part 4 is supplied with a high-level busy signal from the third flash memory 3c. Therefore, during the period from the time T70 to the time T71, the main control part 4 continuously transfers data 9 to the third flash memory 3c using a cache program, without switching to the first or second flash memory 3a or 3b.

Next, the main control part 4 causes the programming of the data 9 to be started at the time T71. Since a period from this time T71 to a time T75 for programming the data 9 is a period for writing data in the second page P2 of the multilevel memory cell C1, the main control part 4 is supplied with a low-level busy signal from the third flash memory 3c. Therefore, during the period from the time T71 to the time T75, the main control part 4 is not allowed to transfer data to the third flash memory 3c.

On the other hand, at the time T70 when the programming of the data 5 ends and a high-level busy signal is supplied from the second flash memory 3b, the main control part 4 determines that the second flash memory 3b is ready for receiving data transferred thereto, switches the destination of transfer of data to the second flash memory 3b, and transfers data 10 to the second flash memory 3b during a period from the time T71 to a time T72. Then, the main control part 4 causes the programming of the data 10 to be started at the time T72. Since a period from this time T72 to a time T76 for programming the data 10 is a period for writing data in the second page P2 of the multilevel memory cell C2, the main control part 4 is supplied with a low-level busy signal from the second flash memory 3b. Therefore, during the period from the time T72 to the time T76, the main control part 4 is not allowed to transfer data to the second flash memory 3b.

On the other hand, at the time T72 when the programming of the data 6 ends and a high-level busy signal is supplied from the first flash memory 3a, the main control part 4 determines that the first flash memory 3a is ready for receiving data transferred thereto. Therefore, the main control part 4 switches the destination of transfer of data to the first flash memory 3a, and transfers data 11 to the first flash memory 3a during a period from the time T72 to a time T73. Thereafter, the main control part 4 performs the same data transfer operation with respect to the first to third flash memories 3a to 3c, so that data are written therein.

With the above-described configuration, the present embodiment achieves the same effects as those of Embodiment 2 described above.

The above-described embodiments are merely illustrative and not limiting. The technical scope of the present invention is specified by the scope of the claims, and any modification falling in the scope of the configuration described therein and equivalent thereto also fall in the technical scope of the present invention.

For example, the foregoing description describes a case where the present invention is applied to a memory card (nonvolatile storage device), but the memory controller of the present invention is not limited to this; it may be applied to another nonvolatile storage device, such as a flash disk.

Further, the foregoing description describes a case where the present invention is applied to a nonvolatile storage device having two or three flash memories (nonvolatile memories) in which 64 multilevel memory cells, each of which has a first page and a second page so as to be capable of storing two-bit data (information), are used for forming physical blocks. The memory controller of the present invention, however, is not limited to those described above, regarding the page configuration of multilevel memory cells, the number of the same, etc., as long as the memory controller has the following configuration: each of the plurality of physical blocks includes the multilevel memory cells, which are p in number, first to p-th multilevel memory cells (p is an integer of not less than 2); in each of the p multilevel memory cells, n pages that are first to n-th pages are provided as physical pages that are writing units for data (n is an integer of not less than 2) wherein as compared with a time required for a data writing operation with respect to the first page, the time required for a data writing operation with respect to a subsequent page increases sequentially as the page number increases; and in the case where in each of the plurality of physical blocks, page numbers are allocated sequentially to all the physical pages provided in the p multilevel memory cells in a predetermined order, the main control part defines, in the plurality of physical blocks, a plurality of page groups that include the physical pages provided in the physical blocks, and groups the physical pages of the plurality of physical blocks so that boundaries between the page groups are defined behind the physical pages as the n-th pages.

Further, in a case other than that described above, such as a case where the first to n-th pages are provided in the multilevel memory cell, it is preferable that when transfer of data to be written is performed with respect to, among the plurality of physical pages included in the page groups, one physical page as the first page, the main control part performs transfer of data to be written with respect to another physical page of the same physical block included in the same page group as the page group including the above-mentioned physical page, and when transfer of data to be written is performed with respect to the physical page as the n-th page, the main control part performs transfer of data to be written with respect to a physical page of a physical block other than the physical block that includes the above-mentioned physical page as the n-th page. This makes it possible that, like in the above-described embodiments, while transfer of data to be written is being performed with respect to the physical page of the n-th page, transfer of data to be written can be performed with respect to a physical page of a physical block other than a physical block that includes the foregoing physical page of the n-th page. Therefore, data can be interleaved and written more surely and efficiently.

Though the above description explains the case in which the main control part groups the physical pages of the plurality of physical blocks so that each of the plurality of page groups includes the physical pages having the same page numbers in the plurality of physical blocks, the main control part of the present invention is not limited to this. The grouping may be performed in such a manner that physical pages having different page numbers in a plurality of physical blocks may be grouped into one page group.

It is preferable, however, that as in the above-described embodiments, physical pages having the same page numbers are grouped into one page group. The reason is as follows: in this case, the grouping of physical pages with respect to a plurality of physical blocks can be carried out easily, and the management of data written in physical pages can be facilitated, whereby the nonvolatile memory driving control can be carried out easily.

Further, though the above description explains a configuration in which the main control part groups physical pages so that physical pages of a plurality of physical blocks included in each of a plurality of flash memories are included in each of a plurality page groups, the present invention is not limited to this configuration.

Physical pages of a plurality of physical blocks included in a single nonvolatile memory may be grouped, and data may be written therein in parallel. More specifically, in a nonvolatile memory having a multiplane structure that is configured so that data writing operations with respect to a plurality of different physical blocks are performed concurrently, physical pages of a plurality of physical blocks in the single nonvolatile memory may be grouped.

Still further, though the above description explains a case where a flash memory of the NAND type is used as the nonvolatile memory, the present invention is not limited to this. The present invention may be applied to a flash memory of another type, such as the MONOS type or the AND type.

### INDUSTRIAL APPLICABILITY

The present invention is useful for a memory controller capable of efficiently interleaving and writing data in a nonvolatile memory in which multilevel memory cells are used, and a nonvolatile storage device configured to perform high-speed memory access.

1. A memory controller for performing drive control with respect to a nonvolatile memory in which multilevel memory cells, each of which is configured to be capable of storing data of two or more bits, are used in physical blocks,
the memory controller comprising a main control part configured to be capable of interleaving and writing data in a plurality of the physical blocks,
wherein each of the plurality of physical blocks includes the multilevel memory cells, which are p in number, first to p-th multilevel memory cells (p is an integer of not less than 2),
in each of the p multilevel memory cells, n pages that are first to n-th pages are provided as physical pages that are writing units for data (n is an integer of not less than 2), wherein as compared with a time required for a data writing operation with respect to the first page, the time required for a data writing operation with respect to a subsequent page increases sequentially as the page number increases, and
in the case where in each of the plurality of physical blocks, page numbers are allocated sequentially to all the physical pages provided in the p multilevel memory cells in a predetermined order, the main control part defines, in the plurality of physical blocks, a plurality of page groups that include the physical pages provided in the physical blocks, and groups the physical pages of the plurality of physical blocks so that boundaries between the page groups are defined behind the physical pages as the n-th pages.

2. The memory controller according to claim 1, wherein the main control part groups the physical pages of the plurality of physical blocks so that each of the plurality of page groups includes the physical pages having the same page numbers in the plurality of physical blocks.

3. The memory controller according to claim 1, wherein in the case where data to be written in the nonvolatile memory are fed from outside, when transfer of data to be written is performed with respect to, among the plurality of physical pages included in the page groups, one physical page as the first page, the main control part performs transfer of data to be written with respect to another physical page of the same physical block included in the same page group as the page group including the above-mentioned physical page, and when transfer of data to be written is performed with respect to the physical page as the n-th page, the main control part performs transfer of data to be written with respect to a physical page of a physical block other than the physical block that includes the above-mentioned physical page as the n-th page.

4. A nonvolatile storage device comprising:
a nonvolatile memory in which multilevel memory cells each of which is configured to be capable of storing data of two or more bits are used in physical blocks; and
the memory controller according to claim 1.
